(19) United States
(12) Patent Application Publication
(10) Pub. No.: US 2004/0064801 A1
(43) Pub. Date: Apr. 1, 2004

(54) Design techniques enabling storing of bit values which can change when the design changes

(75) Inventors: Srinivasan Venkatraman, Bangalore (IN); Anjana Ghosh, Bangalore (IN); Sudheer Prasad, Bangalore (IN); Shankar Kalyanasundaram, Bangalore (IN)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/259,289

(22) Filed: Sep. 30, 2002

(51) Int. Cl. G06F 17/50

(52) U.S. Cl. 716/21; 700/121

(57) ABSTRACT

Techniques which allow a bit value stored/generated by integrated circuits to be changed by changing potentially only one of several masks used to fabricate the circuits. For example, when a single mask is to be re-designed to implement a design change (e.g., to fix minor bugs) and a version identifier is to be changed, the same mask can be used to implement the change in the version identifier as well. An embodiment allows the bit value to be changed any number of times by changing only one mask. As a result, the invention minimizes the number of masks that may need to be changed when implementing design changes.

### BACKGROUND OF THE INVENTION

1. Field of the Invention

The present invention relates to the design of masks used in semi-conductor manufacturing technologies, and more specifically to a method and apparatus for storing bit values which can change when the design of an integrated circuit changes.

2. Related Art

Implementation of integrated circuits typically is performed in various phases. In a typical business flow, designers generate a circuit design at various levels of abstraction (e.g., register transfer level) providing a desired utility. The design may then be converted to a circuit layout representing the various components (e.g., transistors, resistors) and the necessary interconnections.

Masks are then generated based on the circuit layout. A mask generally represents the specific areas on a die at which a layer of a material (e.g., metal, silicon with appropriate doping) needs to be diffused, deposited, etched, etc. The masks are then used in locations commonly known as fabrication units (“fabs”) to implement integrated circuits according to the design layout, typically in large numbers.

Integrated circuits are often designed to store bit values. For example, an integrated circuit may store a number representing a version identifier, which generally represents a number assigned by the designers (or other administrative people) as a design evolves while undergoing changes. Typically, the version identifier is stored in a register and is accessible from software so that the features/bugs present in a given version of the design can be adequately used/dealt with in software effectively.

It is often desirable to change the design of an integrated circuit and the bit values may need to be changed in the resulting new design. For example, bug fixes and addition/deletion of features requires that the design be changed and a version identifier may need to be changed in the integrated circuits to reflect the new version of the design.

In one prior approach, to enable such bit values to be changed, a fuse may be associated with each bit of a version number, and the fuse may be blown or left un-blown depending on the specific value desired for the bit to achieve a desired version number. One problem with such an approach is that the fuses may need to be blown for each integrated circuit, and such blowing may consume unacceptably long (test) time and undesirable overhead.

Thus, it may be desirable to integrate the version number into a design (and thus the masks) such that the manufactured integrated circuits contain the desired version number without requiring substantial additional efforts. Sometimes the design changes are minor and may be implemented by changing only a few layers. Accordingly, it may be desirable to change version identifier without having to modify the other layers.

### SUMMARY OF THE INVENTION

An aspect of the present invention provides an approach which enables a bit value of integrated circuits (to be manufactured) to be changed multiple times by redesigning a (or potentially any) single mask alone each time. The single mask is contained in multiple masks used to fabricate integrated circuits according to a first design of the integrated circuit. For convenience of terminology, the design which relates to the bit value is described as being separate from the design of the rest of the remaining circuit, even though in practicality the two designs together define integrated circuits.

The approach of above can be used to conveniently change the bit values without having to re-design masks merely to change the bit value. For illustration, assuming that some integrated circuits are fabricated and a design change (e.g., to fix a bug or to implement minor changes) necessitates the re-design of a mask, the same mask can be further redesigned to implement a change to the bit value. In an embodiment, the bit value corresponds to a bit of a version identifier of the integrated circuits such that other masks may not need to be redesigned to implement the version identifier change.

An embodiment of the present invention allows the bit value to be changed any number of times by changing only a single mask. In a corresponding approach (“approach one”), the first mask is provided an option to connect a first input and a second input to a first output and a second output in a straight configuration or a cross configuration. In the straight configuration, the first input is coupled to the first output and the second input is coupled to the second output. In the cross configuration, the first input is coupled to the second output and the second input is coupled to the first output.

The connection of above may be viewed as being performed in a first logical portion on the integrated circuits. More logical portions may be provided corresponding to any other masks which need a similar capability to change the bit value. The first and second output of each portion are connected to (or the same as) the first and second input of a subsequent logical portion. Logical values of 0 and 1 may be provided as the two inputs to the first logical portion. The final logical portion generates the desired bit value.

Thus, to implement a change in the bit value, only one of the masks needs to be changed from cross configuration to straight configuration or vice versa. The mask may potentially be redesigned any number of times to cause the changes (from 0 to 1 or vice versa) to be achieved a corresponding number of times.

In an embodiment, the first input is placed diagonally opposite to the second input, and the second output diagonally opposite to the first output. To facilitate control of the bit value in both metal type layers (which can be laid in long strips) and via type layers (which can be laid in small portions only and which connects/disconnects two layers by its presence/absence), two strips of metal layers may be fabricated between, for example, the first input and the first output. One metal strip may be laid to connect the two first input and the first output, and a gap may be placed in the second strip so that the first input is not connected to the first output using the second strip.

Thus, to control the bit value from a via mask, the via may be laid on the first metal strip to achieve a connection, and on the second metal strip to achieve a disconnect. Once the via is laid, the bit value may be controlled from the metal masks by just switching the positions of the first and second metal strips. To then change the bit value using a via related mask, the via position may be switched for one metal strip to the other. Thus, using the connect and disconnects, the cross and straight connections noted with reference to the logical portions, may be achieved.

According to another approach (“second approach”), a register bit cell containing two nodes is provided along with a cell. The register bit cell generates one logical value when the two nodes are in a connected status and another logical value when the two nodes are in a disconnected status. The cell (associated with one of the masks) enables a mask to achieve a connected status or disconnected status, and any of the multiple masks to achieve a disconnected status. In an embodiment, each cell contains a number of fingers equaling the number of layers, and a connect status is achieved by laying all the layers on a finger. The manner in which the layers are manufactured is dependent on type of layer. For example, metal layer is manufactured by deposition.

Multiple of such cells may be provided to provide similar control to a corresponding number of masks to control the bit. The cells corresponding to each bit may be referred to as a block. A number of blocks equaling a number of bits sought to be controlled, may be provided. Thus, in an embodiment according to approach two, a number of blocks (and corresponding register bit cells) equaling the number of bits are provided. Each block contains a number of cells equaling the number of masks which can control the bit value. Thus, for example, a first mask may set the bit value to 1 by achieving a connected status in a corresponding cell in the corresponding block, and any of the masks (including the first mask) can change the value back to 0 by achieving a disconnected status in the same cell.

In an embodiment according to another approach (“third approach”), the block of approach two is changed. The number of cells used in a block corresponding to a bit is proportional to the number of times the bit can change. Assuming a number changes in increments of 1, the most significant bit may thus change once and the least significant bit changes (2^{N}−1) times, wherein N equals, the number of bits in the value. Each block may contain a number of cells equaling (the number of changes+1)/2.

For example, one cell may be contained in a block associated with a first most significant bit, and two cells may be contained in a block associated with a second most significant bit. In general, 2^{N-1} cells may be implemented associated with an Nth bit (counted with the most significant bit as being the first bit).

Further features and advantages of the invention, as well as the structure and operation of various embodiments of the invention, are described in detail below with reference to the accompanying drawings. In the drawings, like reference numbers generally indicate identical, functionally similar, and/or structurally similar elements. The drawing in which an element first appears is indicated by the leftmost digit(s) in the corresponding reference number.

### BRIEF DESCRIPTION OF THE DRAWINGS

The present invention will be described with reference to the accompanying drawings, wherein:

FIG. (FIG.)1 is a flow-chart illustrating a method by which version identification number of integrated circuits can be changed according to an aspect of the present invention;

FIG. 2A is a logical diagram illustrating the details of approach one using which a bit of a version identifier can be changed in potentially any mask any number of times;

FIG. 2B is a flow chart illustrating the details of approach one in an embodiment of the present invention;

FIGS. 3A and 3B are layouts together illustrating a technique/approach by which a connection type associated with each layer/mask can easily be changed from cross to straight or vice versa, which enables a bit value to be controlled to equal a desired value;

FIG. 4 is a logical diagram illustrating the manner in which a bit value can be changed in via and contact type layers which are not generally laid as long strips and used to connect two layers;

FIGS. 5A, 5B, 5C respectively illustrate the manner in which both straight and cross connections can be achieved using either metal or via type layers as desired in a specific situation;

FIGS. 6A and 6B are block diagrams illustrating the manner in which a bit of a version identifier can be controlled from any layer in an embodiment according to approach two;

FIG. 7 is a logical structure illustrating the details of a cell in an embodiment of approach two;

FIGS. 8A, 8B, 8C and 8D are logical structures of a cell illustrating the manner in which a bit value can be changed from 0 to 1, then 1 to 0, and again 0 to 1 in an embodiment according to approach two;

FIG. 9 is a logical structure illustrating the details of an example block in an embodiment according to approach two;

FIG. 10 is a logical structure illustrating a cell used in an embodiment according to approach three;

FIGS. 11A, 11B and 11C are logical structures illustrating with an example the manner in which a block with single cell can be used to implement the changes required for an MSB of a value to be stored; and

FIGS. 12A, 12B, 12C, 12D and 12E are logical structures illustrating with an example the manner in which a block with two cells can be used to implement the four changes required for bit 2 (bit next to MSB).

### DETAILED DESCRIPTION OF THE PREFERRED EMBODIMENTS

### 1. Overview and Discussion of the Invention

An aspect of the present invention allows a bit value to be changed any number of times potentially using any one of the several masks defined by a circuit layout. As a result, when a bit value needs to be changed associated with a layout change, the bit value change can be implemented by changing potentially only a single mask. By choosing the single mask to be a mask which would otherwise need to be changed to implement a change in the corresponding integrated circuit, the other masks need not be changed solely for the purpose of changing version identifiers, thereby decreasing the costs to implement the overall changes.

For purpose of illustration, the embodiments below are described with reference to changing the version identifier (bit values). However, it will be apparent to one skilled in the relevant arts how to use the approaches/techniques in relation to storing other types of data values by reading the disclosure provided herein. Such other embodiments are contemplated to be within the scope and spirit of various aspects of the present invention.

Thus, several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the invention.

### 2. Method

FIG. 1 is a flow-chart illustrating a process by which version identification number of integrated circuits can be changed according to an aspect of the present invention. The method begins in step 101 in which control passes to step 110.

In step 110, an approach is implemented which enables a bit of the version identifier to be changed any number of times by re-designing a mask used to fabricate integrated circuits. In general, it is desirable to implement the design approach in all masks which are likely to be changed when a layout changes at least in minor respects. Thus, if a layer needs to be re-designed to implement a design change, the same layer can then be used to implement a change in the bit value also. In addition, a layer can be implemented to change all bits of a version identifier. A few example approaches are described in sections below for illustration.

In step 120, a present version identifier to be used for integrated circuits is determined. The determination of version identifier typically depends on the extent of design changes made, the number of different/new masks to be generated, etc. Often one portion of a number indicates a major release and a second portion indicates the minor modifications to the designs. For example, a version number of 1.2 may be used to indicate a major release of 1.0, and that 2 further changes have been implemented within the first major release.

In step 130, the version identifier (of step 120) is implemented within the masks which further reflect the design of the integrated circuits sought to be fabricated. In step 140, integrated circuits are fabricated according to the masks. The generated integrated circuits would include the present version identification number.

In step 150, a determination is made whether a mask needs to be changed to implement desired design changes on integrated circuits. In some situations, multiple masks may also need to be changed. The determination of the specific masks to be changed can be performed in a known way. Control passes to step 160 if the mask(s) need to be changed, and to step 190 otherwise. In step 190, the masks are released to production, i.e., integrated circuits are manufactured for the intended use, sale, etc.

In step 160, a determination is made whether to change the version identifier. Typically, the designers make the decision based on various factors such as the extent of change, the need for identifying the presence of a change from the previous design version, etc. Control passes to step 170 if the version number needs to changed, and to step 140 otherwise.

In step 170, the version number is changed using the mask of step 150 according to the design approach of step 110. Control then passes to step 140. Thus, using the approach of step 110, several changes to the version number can be implemented as a design changes over time. As other masks (which need not be changed to implement design changes) need not be changed at least to implement the version identifier, the overall cost and time to fabricate integrated circuits may be minimized. Several example approaches (of step 110) are described below.

### 3. Approach One

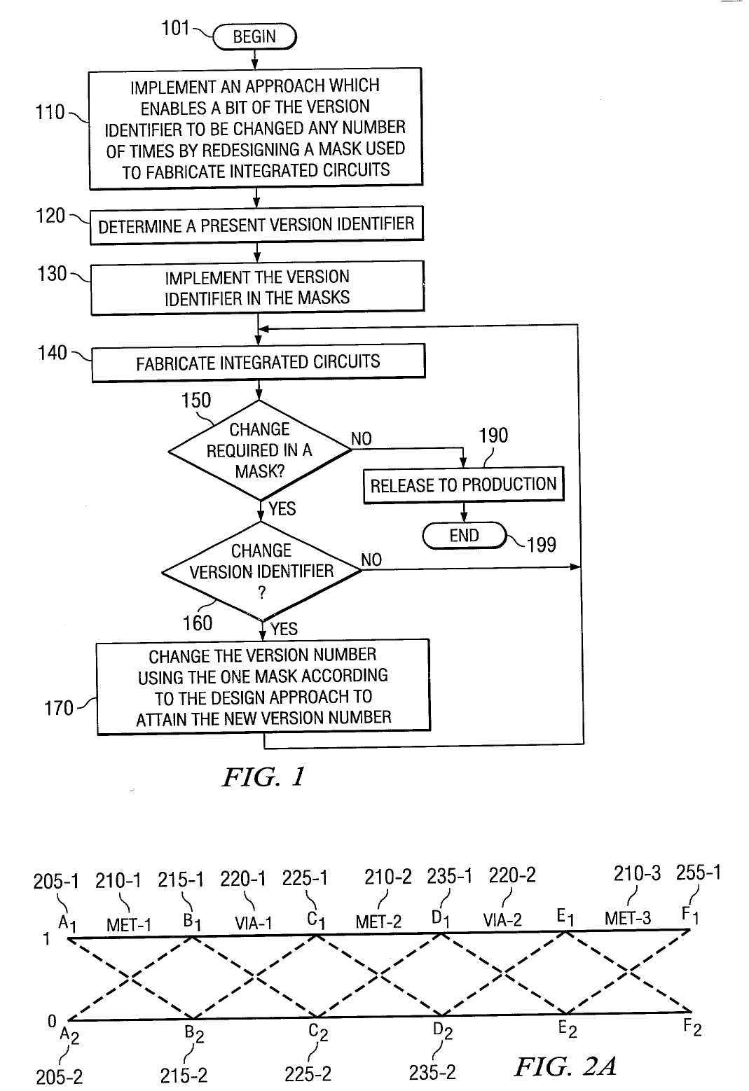

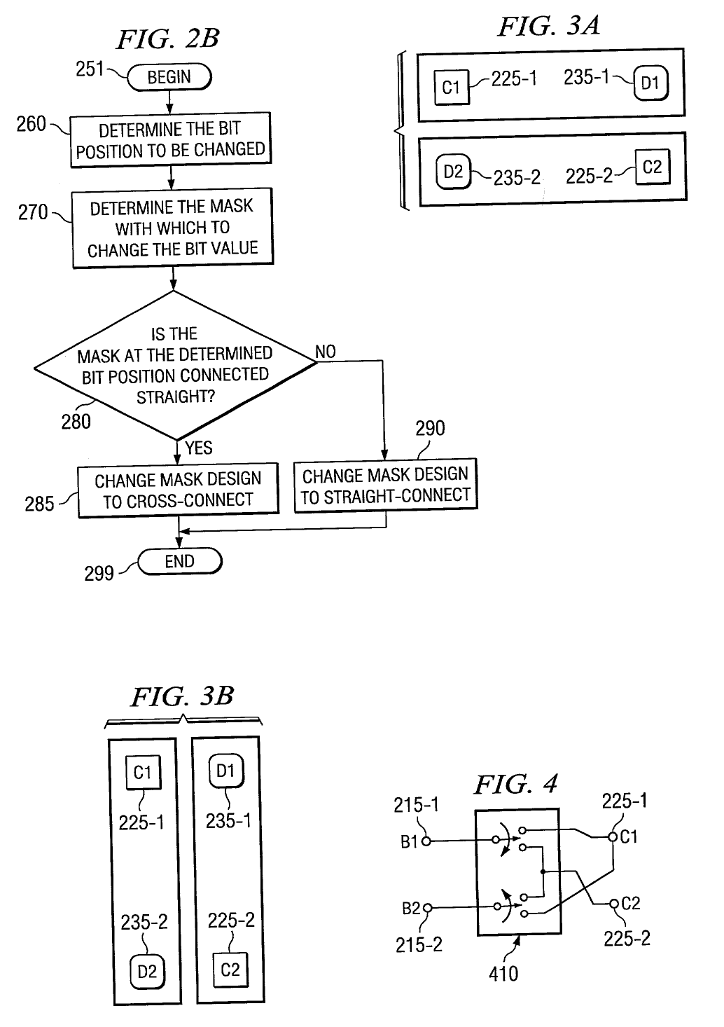

An approach according to an aspect of the present invention provides a designer the ability to change a bit of the version identifier by redesigning any mask without having to effect changes to other masks. The approach is described with reference to FIGS. 2A and 2B.

3.A. Circuit Diagram According to Approach One

FIG. 2A is a logical diagram illustrating the manner in which a bit of a version identifier can be changed in potentially any mask. Thus, the circuit of FIG. 2A may need to be replicated multiple times equaling the number of bits contained in a version identifier. FIG. 2A is shown containing a sequence of layers, with the output of one layer providing an input to the next layer.

Metal layers 210-1 through 210-3, and via layers 220-1 and 220-2 are shown in alternative logical portions. The first layer (metal layer 210-1) is shown receiving a logical 1 and logical 0 on the two inputs A1 (205-1) and A2 (205-2). While two inputs and outputs are shown, one can be generated by inverting the other, and the signals thus generated also are referred to as inputs and outputs respectively. The manner in which the bit value is controlled by various layers in FIG. 2A, is described with reference to metal layer 210-2 for illustration. However, the remaining layers (210-1, 210-3, 220-1 and 220-2) of FIG. 2A may also be implemented in a similar manner.

Metal layer 210-2 is shown containing two inputs C1 (225-1) and C2 (225-2), and two outputs D1 (235-1) and D2 (235-2). The two inputs can be connected to the two outputs in either a straight manner (shown as solid line) or cross manner (dotted lines). Assuming that the configuration of the other layers is fixed, cross connect configuration and straight configuration cause different logical values to be generated at output F1. Such a principle of operation can be used to change the bit of the version identifier by re-designing only metal layer 210-2 (if so desired) as described below with reference to FIG. 2B.

3.B. Method According to Approach One

FIG. 2B is a flow chart illustrating an approach to change a bit of version identifier using any one of the masks. The approach is described with reference to metal layer 210-2 for illustration as noted above. The approach begins in step 251 in which control passes to step 260.

In step 260, a specific bit position to be changed to obtain a desired version identifier is determined. While the flow-chart is described with reference to changing a single bit, multiple bit positions can be changed within a single mask, as will be apparent to one skilled in the relevant arts based on the disclosure provided herein.

In step 270, a specific mask in which to implement the change of step 260, is determined. In general, a mask requiring a change independent of changes necessary to implement the version identifier, is selected to implement the change to the version identifier. Such an independent change may be necessitated by design changes (e.g., for bug fixes).

In step 280, a determination is made whether the layer corresponding to the specific mask (of step 270) is connected straight or cross. If the connection at the bit position is cross, control passes to step 290, otherwise, control passes to step 285. The two steps 290 and 285 operate to change the type of connection from cross to straight or the other way, as described below.

In step 285, the mask is re-designed to change the connection from straight connect to cross connect. Assuming the relevant design in the other layers is not changed, the redesign causes the value provided at output 255-1 to be changed (as desired). Similarly, in step 290, the mask is re-designed to change the connection from cross connect to straight connect to modify the value at the bit position. The approach ends in step 299.

Thus, to change a bit value, the type of connect is changed (from cross to straight or vice-versa) in comparison to a previous design. Several approaches can be used to implement such a connection change within a mask. An example approach is described below with reference to FIG. 3.

3.C. Example Layout Supporting Approach One

FIGS. 3A and 3B together illustrate a layout technique, which permits the connection type to be easily changed from cross to straight or vice versa in mask. As depicted in both the Figures, the two inputs and outputs are located in diagonally opposite positions. As an illustration, input C1 225-1 is in a position diagonally opposite to input C2 225-2.

FIG. 3A depicts the manner in which the points need to be connected (i.e., C1 225-1 and C2 225-2 respectively connected to D1 235-1 and D2 235-2) for a straight connection and FIG. 3B depicts the manner in which the points need to be connected for a cross-connection (C1 225-1 and C2 225-2 respectively connected to D2 235-2 and D1 235-1). Due to such location of the four points, the changes in bit values can be implemented easily within each mask.

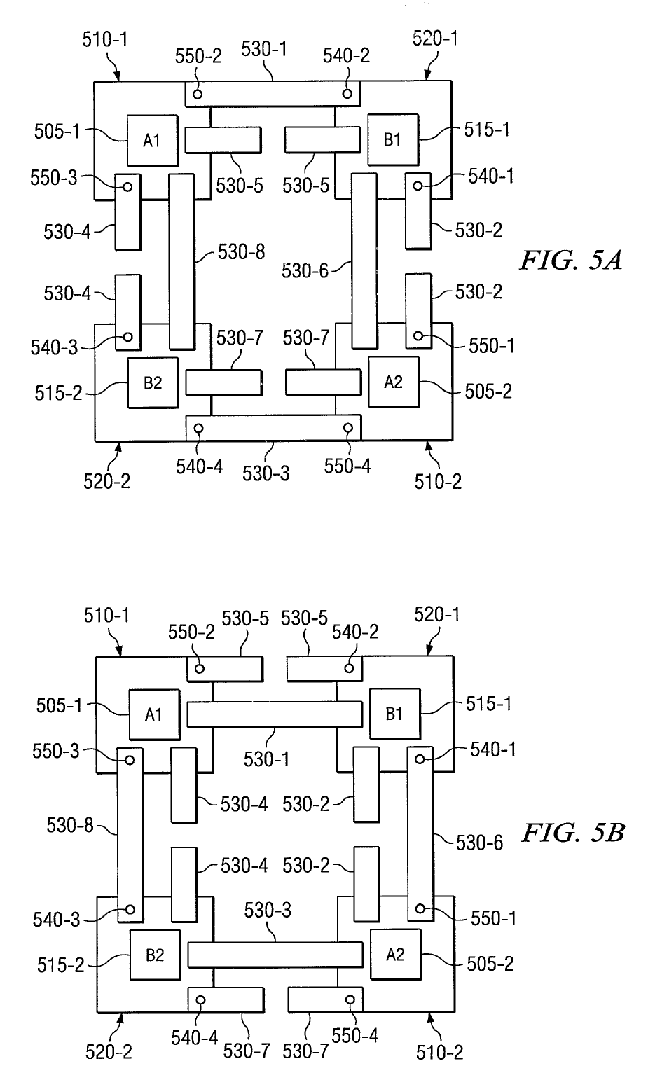

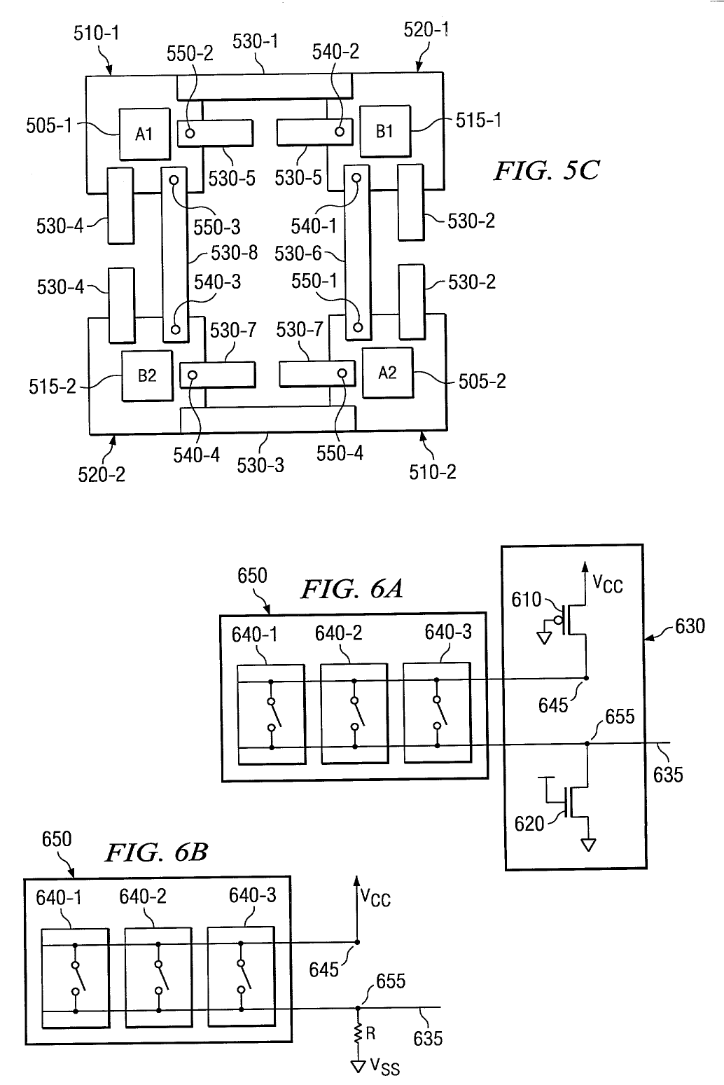

The approach of FIGS. 3A and 3B generally easily lends to implementations within metal layers since metal generally can be deposited (laid) in the form of long strips. However, layers such as via and contact are often laid as small areas (e.g., square) and are meant to connect two layers, and additional challenges may be presented. The manner in which the challenges may be addressed is described below with reference to FIGS. 4 and 5A-5C.

3.D. Layers Connecting Other Layers

FIG. 4 is a logical diagram illustrating the manner in which a bit value can be changed in via and contact type layers which occupy only a small area. The diagram is described with reference to via layer 220-1 for illustration. However, the approach can be used in other layers as well.

Layer 220-1 is shown containing inputs B1 215-1 and B2 215-2, outputs C1 225-1 and C2 225-2, and ganged switch 410. In one configuration of ganged switch 410, inputs B1 215-1 and B2 215-2 are respectively connected to outputs C1 225-1 and C2 225-2 (straight connection). In another configuration of ganged switch 410, inputs B1 215-1 and B2 215-2 are respectively connected to outputs C2 225-2 and C1 225-1 (cross connection). The manner in which such a configuration can be implemented is described below with reference to FIGS. 5A-5C. FIGS. 5A-5C further illustrates how the connections of multiple layers inter-operate in an example scenario.

3.E. Example Layout Technique

FIG. 5A depicts a compact layout structure with both metal and via layers together, such that either layer can be used to effect a change in bit value. Metal layer represents a layer which can be laid in the form of long strips and via layer represents a layer which can be laid usually only in small areas and is meant to connect two layers (e.g., two metal layers). However, the technique can be implemented with other layers also.

The layout of FIG. 5A is shown containing inputs A1 505-1 and A2 505-2, outputs B1 515-1 and B2 515-2, metal 1 layers 510-1 and 510-2, metal 2 layers 520-1 and 520-2, metal links 530-1 through 530-8, vial layers 540-1 through 540-4 and via 2 layers 550-1 through 550-4. The configuration there represents a straight connection using one of the two metal layers as described below with reference to each of the components.

Metal links 530-1 through 530-8 may be implemented either with metal 1 or metal 2 layers. Metal link 530-1 provides straight connection between input A1 505-1 and output B1 515-1 (using vias 550-2 and 540-2), and metal link 530-3 provides straight connection between input 505-2 and output 515-2 (using vias 550-4 and 540-4).

As is well known, via layer is used to short two different metal layers. The specific places in which the via layer may be laid is shown as small dots. However, the actual locations in which the via layer is laid depends on the specific choice of metals and the connectivity desired. For example, assuming that links 530-1 through 530-8 are all implemented using metal 1 or metal 2, only four vias would be required. On the other hand, if all the links are implemented using a different metal than metal 1 and metal 2 (e.g., metal 3), eight vias may be required.

The connection from straight to cross can be changed either with a metal layer or a via layer as described below with FIGS. 5B and 5C respectively.

3.F. Changing Connection Type Using Metal Layer Only

FIG. 5B is a layout structure illustrating the manner in which cross connection can be achieved (changed from the straight connection of FIG. 5A) by changing a metal layer without disturbing via layers. Only the changes in comparison to FIG. 5A are noted here for conciseness.

The connection between A1 505-1 and B1 515-1 is removed by interchanging the inner link 530-5 with outer link 530-1. In other words, as link 530-1 is not connected by vias, A1 505-1 is not effectively (electrically) connected to B1 515-1. Similarly, A2 505-2 is disconnected from B2 515-2 by interchanging the inner link 530-3 with broken interlink 530-7.

The connection between A1 505-1 and B2 515-2 is achieved by interchanging the inner link 530-8 with outer link 530-4. In other words, as link 530-8 is connected by vias, A1 505-1 is effectively (electrically) connected to B2 515-2. Similarly, A2 505-2 is connected to B1 515-1 by interchanging the inner link 530-6 with broken interlink 530-2. Links 530-1 and 530-3 enable the connection type to be changed later using via layer even though the links provide no useful connection in the configuration of FIG. 5B.

Thus, by merely modifying the design of a metal layer, the connection type can be changed from straight to cross. The manner in which the connection type can be changed from cross to straight will be apparent to one skilled in the relevant arts by reading the disclosure provided herein. The description is continued with reference to the manner in which the connection type can be controlled by via layers.

3.G. Changing Connection Type Using Via Layer Only

FIG. 5C is a layout structure illustrating the manner in which cross connection can be achieved (changed from the straight connection of FIG. 5A) by changing a via layer without disturbing the metal layers. Only the changes in comparison to FIG. 5A are noted here for conciseness.

The connection between A1 505-1 and B1 515-1 is removed by moving vias 540-2 and 550-2 from outer link 530-1 to the inner broken link 530-5. In other words, as link 530-1 is not connected by vias, A1 505-1 is not effectively (electrically) connected to B1 515-1. Similarly, A2 505-2 is disconnected from B2 515-2 by moving vias 540-4 and 550-4 from outer link 530-3 to the inner broken link 530-7.

The connection between A1 505-1 and B2 515-2 is achieved by moving vias 540-3 and 550-3 from outer broken link 530-4 to the inner link 530-8. In other words, as link 530-8 is connected by vias, A1 505-1 is effectively (electrically) connected to B2 515-2. Similarly, A2 505-2 is connected to B1 515-1 by moving vias 540-1 and 550-1 from outer broken link 530-2 to the inner link 530-6. Vias 550-2, 540-2, 550-4 and 540-4 enable the connection type to be changed using metal layer (as described above with FIG. 5A) even though the vias provide no useful connection in the configuration of FIG. 5C.

Thus, by merely modifying the design of a via layer, the connection type can be changed from straight to cross. The manner in which the connection type can be changed from cross to straight will be apparent to one skilled in the relevant arts by reading the disclosure provided herein.

From the above, it may be appreciated approach one enables any bit(s) of a version identifier to be changed by redesigning potentially only one layer. The description is continued with reference to another approach which provides similar feature.

### 4. Approach Two

An aspect of the present invention provides another approach using which a version identifier can be changed any number of times on integrated circuits. In an embodiment, multiple cells are used, with each cell being designed to provide a corresponding mask/layer the ability to cause one logical value (e.g., ‘1’) to be generated and all the mask/layers to cause another logical value (e.g., ‘0’) to be generated. In other words, each relevant mask has an associated cell to force a logical value of 1 to be generated and all the relevant masks have the ability to force the output value to be ‘0’ in each cell. Using such a feature, each mask can control a bit of the version identifier as described below in detail.

4.A. Circuit Diagram According to Approach Two

FIG. 6A is a circuit diagram illustrating the manner in which a bit of a version identifier can be controlled from any layer in an embodiment of the present invention. The circuit there is shown containing block 650 and register bit cell 630. The two components are described below in further detail.

Register bit cell 630 is shown containing pull up transistor 610 and weak pull down transistor 620 respectively implemented as P-channel and N-channel transistors. The drains of transistors 610 and 620 are respectively shown connected to nodes 645 and 655. A short (depicted logically in a closed state by the respective switch within each cell) in any of the cells (described below) of block 650 cause nodes 645 and 655 to be connected and a value of 1 to be generated on path 635. If no connection exists (open state of the switch) in the cells, a value of 0 would be generated by the weak pull-down.

It should be understood that the arrangement of weak pull down and strong pull up can be implemented using several alternative embodiments. An example alternative embodiment is depicted in FIG. 6B. Only the differences of FIG. 6B from FIG. 6A are noted in this paragraph for conciseness. As may be readily appreciated, the resistor R in combination with Vss provides the necessary pull-down and the Vcc connection to node 645 provides the pull-up.

Continuing with combined reference to FIGS. 6A and 6B, block 650 is shown containing three cells 640-1, 640-2 and 640-3. Only three cells are shown assuming it is desirable to control a bit of the version identifier in three masks. In general, a block contains the same number of cells as the number of layers with which the corresponding bit is desired to be controlled. Also, a number of blocks and register bit cells equaling the number of bits in the version identifier may also be implemented to control all bits from all relevant masks.

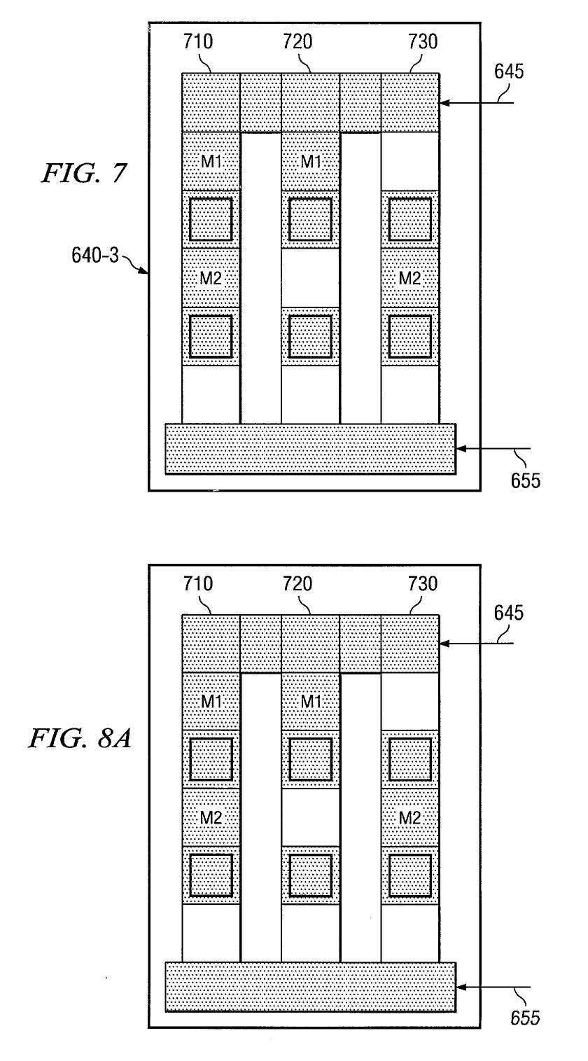

Each of the cells 640-1 through 640-3 controls the connection between nodes 645 and 655. Each cell can be used to connect with a particular layer and to disconnect with any of the layers. For example, cell 640-3 can be used to connect with metal layer three and disconnect with any of the layers present as described below with reference to FIG. 7. The remaining cells in block 650 can be implemented in similar manner

4.B. Cell Structure

FIG. 7 depicts the structure of cell 640-3 in one embodiment. Cell 640-3 is shown containing three fingers—first finger 710, second finger 720, and third finger 730. Each finger is shown containing space for laying three illustrative layers, represented as M1, M2 and M3 respectively. However, at least one metal is shown missing in each finger. The manner in which the metals can be laid to control the bit value is described below in further detail.

Finger 710 provides a connection between nodes 645 and 655 when all the three metals M1, M2 and M3 are laid. Thus, finger 710 would provide the connection if M3 is also laid (in addition to M1 and M2 shown already). In such a situation, the logical switch within cell 640-3 of FIGS. 6A and 6B, may be viewed as being in a closed/on state. Any of the layers can cause the disconnect by removing (not laying) the corresponding layer in the fingers. The logical switch of FIGS. 6A and 6B may then be viewed as being in an open state. The operation of the remaining fingers also is similarly described.

A disconnect between nodes 645 and 655 is obtained when each of the three fingers (710, 720, and 730) have at least one of the three metal (M1, M2 and M3) segments missing. The structure of FIG. 7 would provide a disconnect between nodes 645 and 655 since each of the three fingers has at least one metal segment missing. That is, M3, {M2 and M3} and {M1 and M3} are respectively missing in fingers 710, 720 and 730. The manner in which the cells can be used to control a bit value is described below with examples.

4.C. Example Illustrating Approach Two

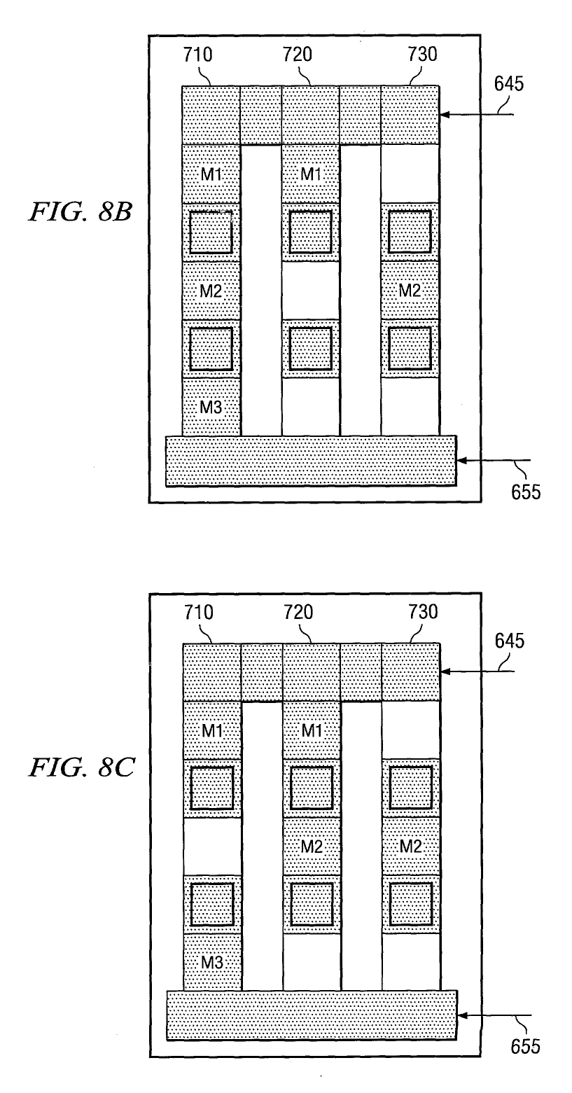

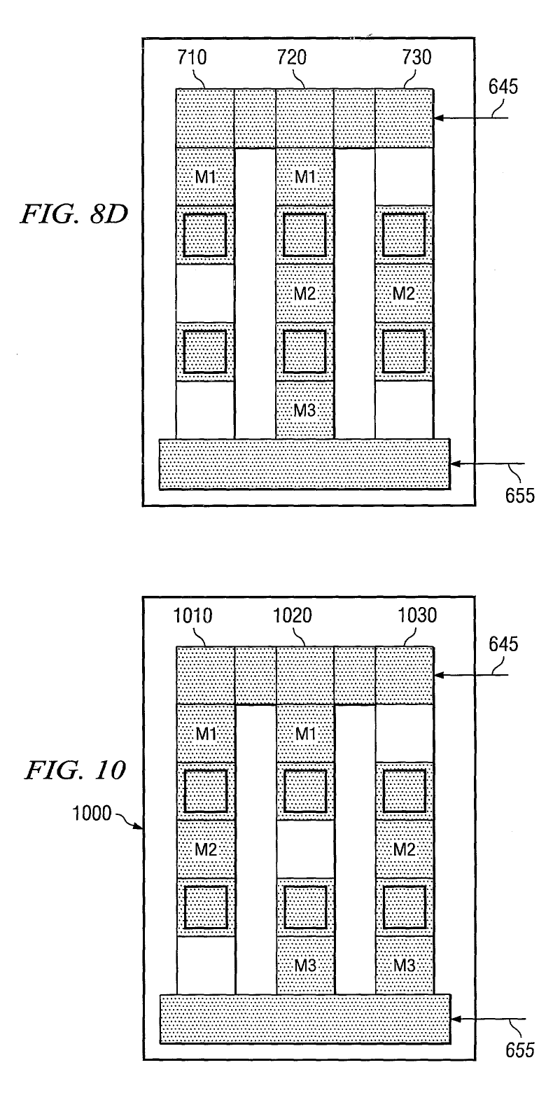

FIGS. 8A, 8B, 8C and 8D together illustrate with an example the manner in which a cell provides the ability to connect nodes 645 and 655 using one mask and to disconnect using any mask. For illustration, the description is provided with reference to cell 640-3 assuming metal M3 layer controls the connection and any of the layers M1-M3 control the disconnection.

FIG. 8A represents a structure in which cell 640-3 is in a disconnect mode. The disconnection is achieved as a metal segment is missing in each of the three fingers (710, 720, and 730). M3 is missing from all fingers, and in addition, M2 is missing from second finger 720 and M1 is missing from third finger 730. The disconnection (of nodes 645 and 655) causes a value of 0 to be generated on path 635 unless other cells cause a 1 to be generated.

It is now assumed that the value on path 635 needs to be changed to 1 using metal M3 layer. As noted above, cell 640-3 is used for connecting nodes 645 and 655, which would cause a 1 to be generated on path 635. The manner in which the layout of cell 640-3 can be changed to achieve a connect status, is described below with reference to FIG. 8B. Only the differences from FIG. 8A are described in the interest of conciseness.

FIG. 8B depicts a structure in which cell 640-3 causes a connect status. In particular, finger 710 is shown with all the layers laid, causing nodes 645 and 655 to be connected. The connection causes a 1 to be generated on path 635.

It is now assumed that the value on path 635 needs to be changed to a 0. The result can be achieved by removing (not laying) any of the metals M1-M3 from finger 710, which is the only finger providing the connection. It is assumed that the disconnect status needs to be achieved using only M2, for example, because mask related to M2 is being re-designed for other reasons. The disconnect status is achieved as illustrated with reference to FIG. 8C.

FIG. 8C depicts a structure in which cell 640-3 causes a disconnect status. In relation to FIG. 8B, the disconnect is achieved by removing metal M2 from finger 710. In addition, metal M2 is laid in second finger 720. The filling in the missing segment ensures that the general structure of the cell remains unchanged after each release. The general structure provides the ability to connect with M3 mask and disconnect with any of the three layers.

Now assuming that the version identifier bit needs to be changed to logic ‘1’, the corresponding changes to structure (in comparison to FIG. 8C) are described with FIG. 8D.

FIG. 8D depicts a structure in which cell 640-3 causes a connection between nodes 645 and 655. In comparison to FIG. 8C, connection is achieved by filling metal M3 in second finger 720. Metal M3 is shown removed in first finger 710 to retain the general structure of cell 640-3.

Thus, a cell provides a layer the ability to change a version identifier bit any number of times. As noted above, multiple cells form a block. The details of block 650 in an embodiment are described below.

4.D. Example Block Structure

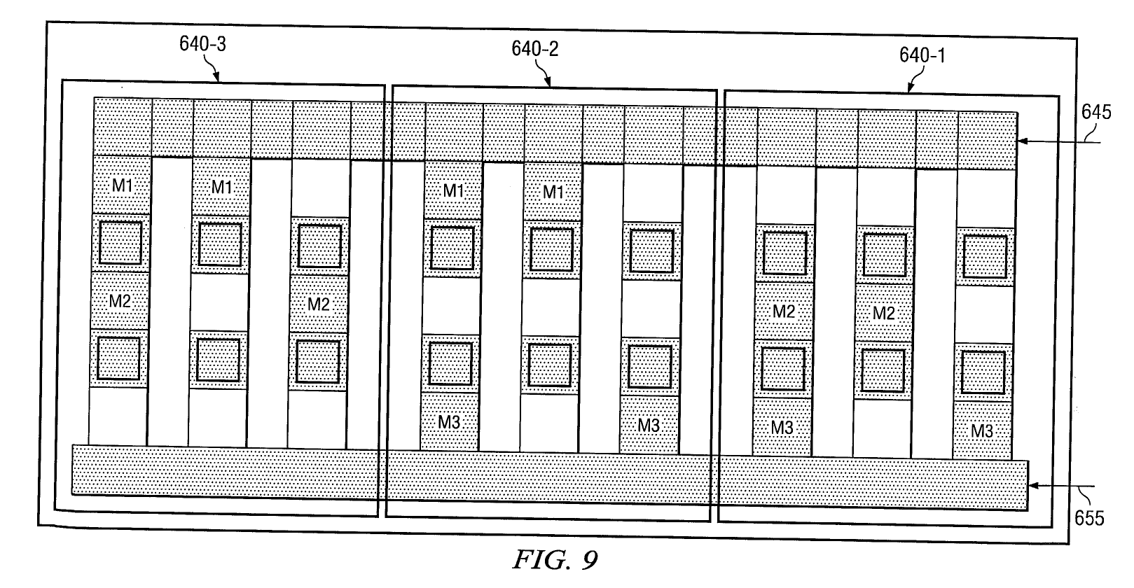

FIG. 9 contains the details of cells 640-1, 640-2 and 640-3 in one embodiment. Cells 640-3, 640-2 and 640-1 respectively enable connection with metals M3, M2 and M1. Thus, when a ‘1’ is sought to be achieved using a specific metal, only the mask portion in the corresponding cell may need to be modified. For example, to achieve a ‘1’ using metal M2, only the portion of metal M2 within structure of cell 640-2 may need to be modified (for the purpose of modifying the version identifier bit).

To achieve a ‘0’, the cell which is presently causing a connect status (between nodes 645 and 655) needs to be modified. The specific layer to be used for disconnecting may be determined by considerations such as whether the layer needs to be independently redesigned for other purposes.

Accordingly, using the blocks/cells described above, a version identifier can be modified any number of times as necessitated by independent design changes.

It may be desirable to implement the version identifier changes while minimizing the number of cells, for example, to minimize area. Accordingly, the number of cells required in the above-noted approach (two) are computed below first. The manner in which an aspect of the present invention enables the number of cells to be reduced is described then with reference to approach three.

4.E. Number of Cells Needed in Approach Two

Assuming that all M-bits of a version number need to be changed using any of ‘N’ layers, a total of N*M (wherein ‘*’ represents multiplication) number of cells would be required in an embodiment described above. For example, if a version identifier contains 4 bits and 6 layers need to be provided the ability to change version identifiers, then total number of cells required is 24. The manner in which the number of cells can be reduced at least in some practical applications is described below.

### 5. Approach Three

An aspect of the present invention takes advantage of the fact that the values in each bit position do not change the same number of times assuming that the version number is incremented by 1 for each version identifier change. In such a scenario, assuming a version number of N-bits, the least significant bit (LSB) has utmost (2^{N}) values, the second least significant bit has (2^{N-1}) values, . . . , and the most significant bit (MSB) has utmost 2¹ values; wherein the “value” of a bit is defined to be a new one anytime the bit changes.

Thus if, for example, a bit changes from an initial value of “0” to “1” and then again to “0”, the bit is said to have taken 3 values although the absolute configuration of the bit has only two values “0” and “1”. Following this definition, for a 4 bit version identifier, bit 0 (LSB) changes 15 times (and thus has 16 values), bit 1 changes 7 times (and thus has 8 values), bit 2 changes 3 times and bit 3 (MSB) changes 1 time (and has 2 values) for all combinations of four bits.

As described below, only one cell may be needed to implement the MSB, 2 cells for the second MSB, . . . , and 2^{N-1} cells would be required for the LSB. Accordingly, in relation to FIGS. 6A and 6B, the block structure corresponding to each bit position would change. In addition, the manner in which each cell in the block would be used also changes. Accordingly, the manner in which a cell is used in approach three is described first. The block structures are then described with examples for illustration.

5.A. Cell in Approach Three

FIG. 10 depicts the logical structure of cell 1000 used in an embodiment according to approach three. Cell 1000 is shown containing three fingers 1010, 1020, and 1030, equaling the number of layers (M1, M2 and M3). Each finger contains room for each of the layers. The embodiment is described with reference to three layers for illustration. However, cell 1000 can be modified to contain any number of layers.

Cell 1000 can be placed in connect or disconnect state using any of the three layers. The cell of FIG. 10 is in a disconnect state as all the three fingers have at least one layer missing. A single cell provides only two changes (e.g., 0 to 1 and then again to 0). If more changes are required, additional cells may be required. In general, 2^{N-1} cells would be required to represent 2^{N} values (or 2^{N}−1 changes) as illustrated below.

5.B. Block Structure for Most Significant bit (MSB)

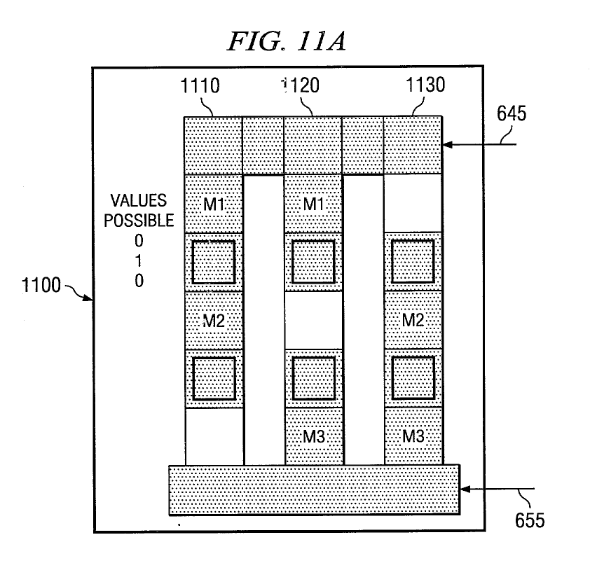

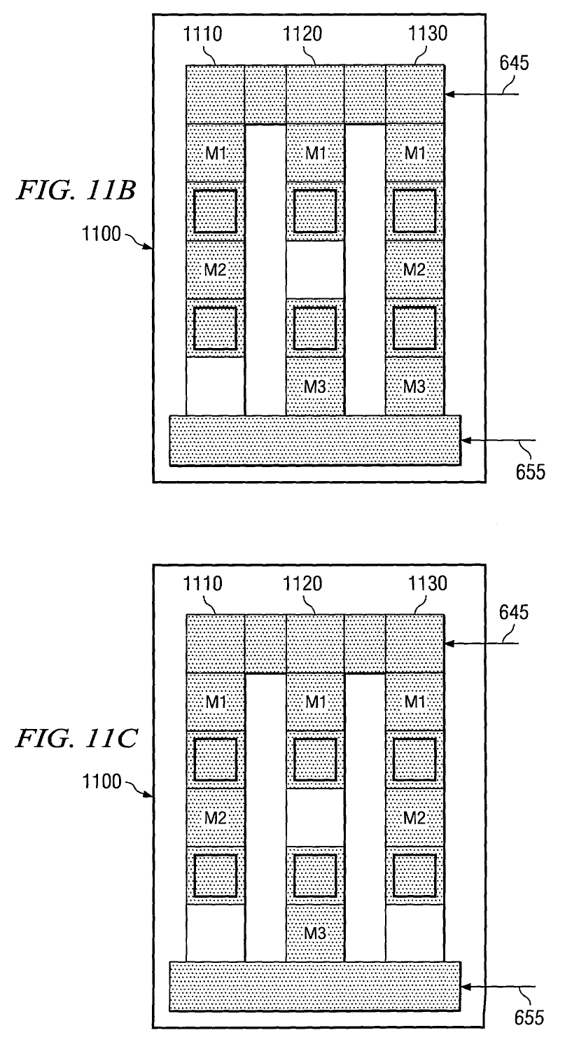

FIGS. 11A, 11B and 11C together illustrate with an example the manner in which block 1100, containing a single cell, can be used to implement the two changes required for an MSB. FIG. 11A depicts the logical structure with which the cell can be implemented, FIG. 11B illustrates the changes to the structure of FIG. 11A when the cell is changed from a disconnect to a connect state, and FIG. 11C represents the changes when the cell status is changed back to the disconnect state.

FIG. 11A represents a structure in which block 1100 is in a disconnect mode. The disconnection is achieved as a metal segment is missing in each of the three fingers (1110, 1120, and 1130) of the only cell (hereafter referred by 1100) present in block 1100. The disconnection between nodes 645 and 655 causes a value of ‘0’ to be provided on path 635.

It is now assumed that the value is to be changed to a 1 using metal M1 mask only. As noted above, block 1100 can be used for connecting nodes 645 and 655, which would cause a ‘1’ to be generated on path 635. The manner in which the implementation of metal segments in block 1100 can be changed to achieve a connect status, is described below with reference to FIG. 11B. Only the differences from FIG. 11A are described in the interest of conciseness.

FIG. 11B represents a structure in which block 1100 is in connect mode. In relation to structure of FIG. 11A, metal M1 is shown laid in Finger 1130. A connect status is achieved as all metal layers (M1, M2, and M3) are present in finger 1130. The connection between nodes 645 and 655 causes a value of ‘1 ’ to be provided on path 635.

It is now assumed that the value is to be changed back to ‘0’ using metal M3 only. As may be appreciated metal M3 needs to be removed from Finger 1130 (which was causing the connect status). FIG. 11C depicts the corresponding logical structure which causes the disconnect state, and thus a value of 0 is generated on path 635. Accordingly, a single cell can be used to successfully indicate 2 transitions (from 0 to 1 and then back to 0).

Now hypothetically assuming that the value is to be changed back to 1 using metal M1 mask, it may be readily appreciated that finger 1130 of FIG. 11C cannot be changed any further to achieve the desired value using only M1 mask. In particular, connection with M1 mask is not possible in cell 1100 as all fingers are already filled with M1 mask (in FIG. 11C). Thus, extra cells are required to provide more than two changes as described below in further detail.

5.C. Block Structure for Bit 2

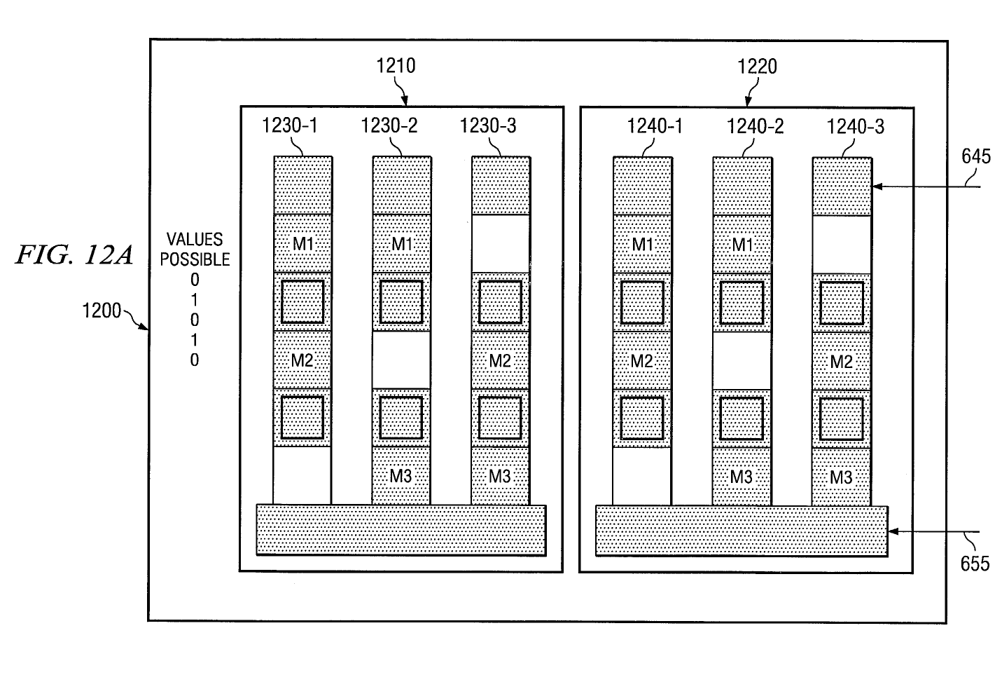

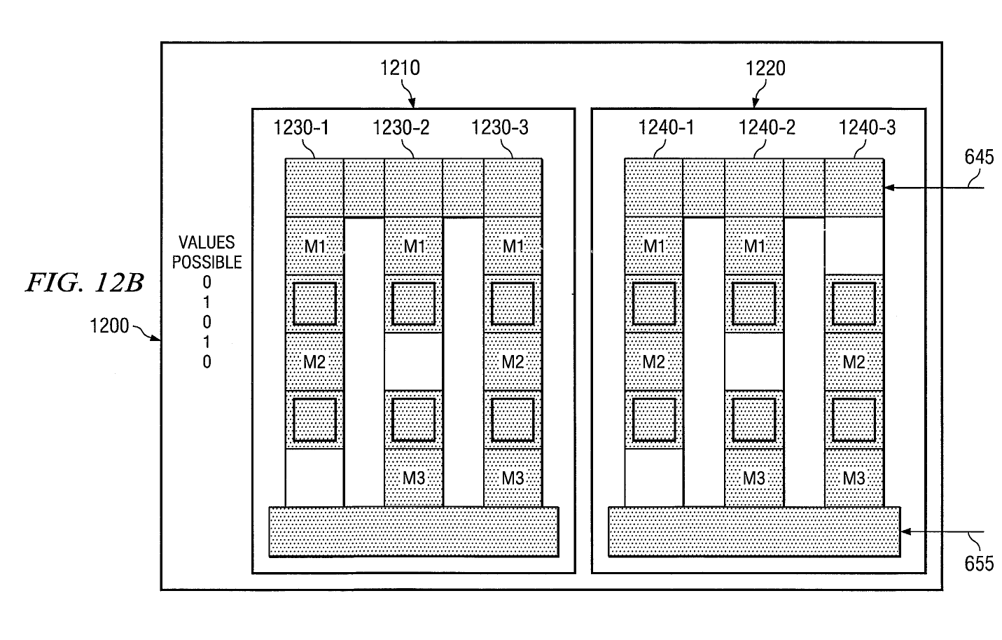

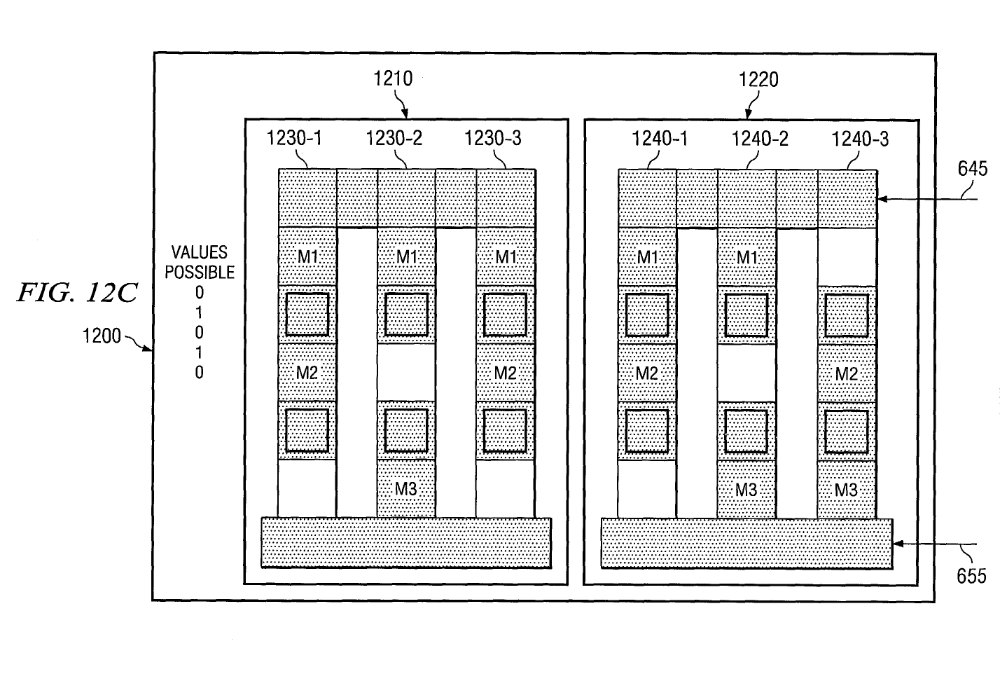

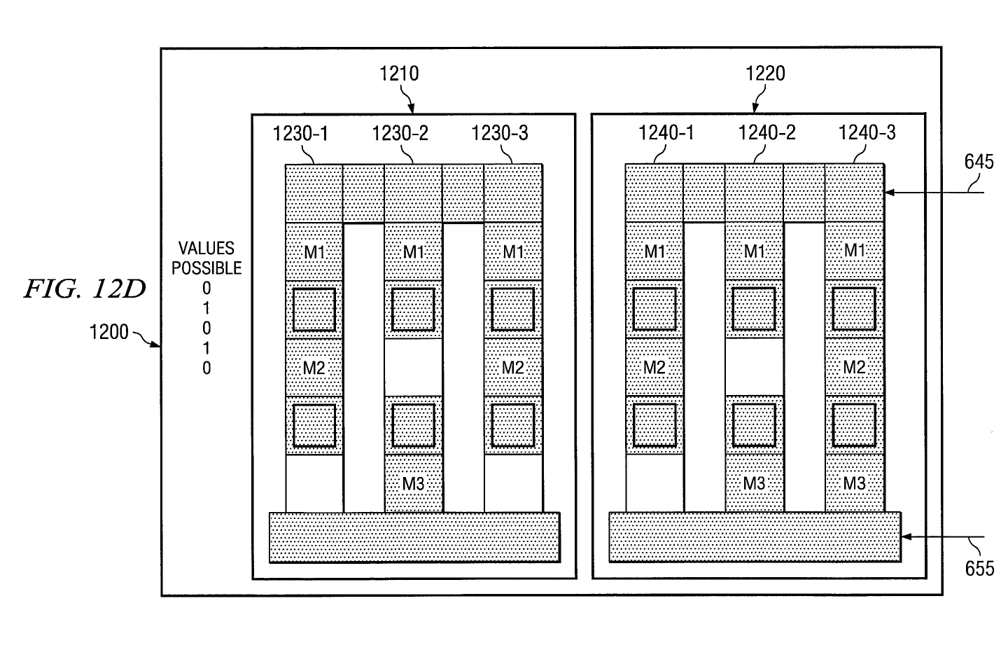

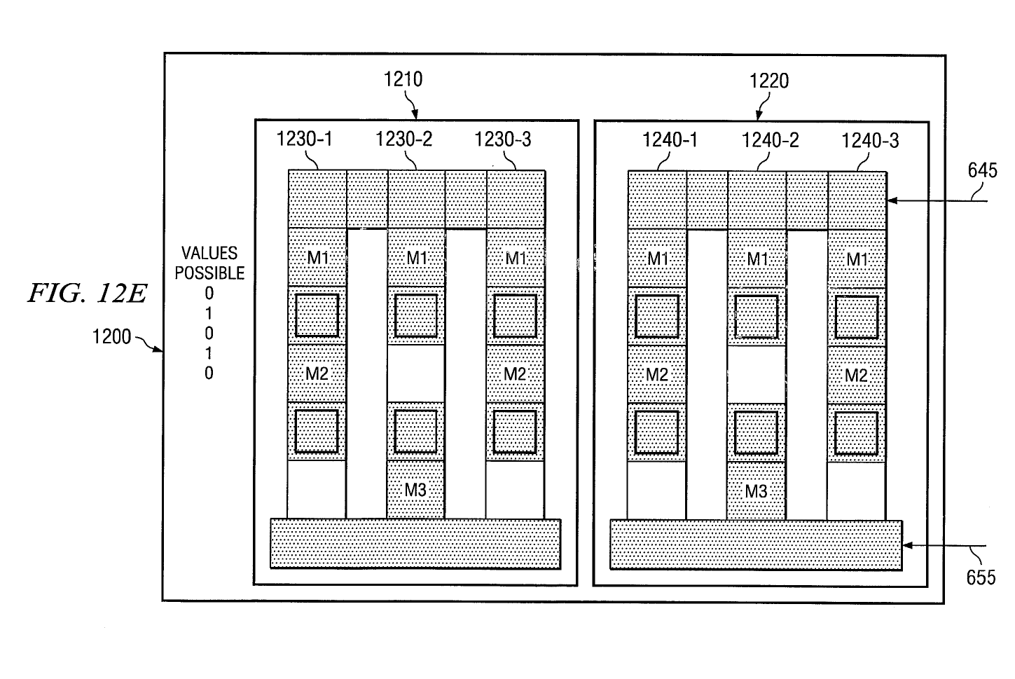

FIGS. 12A, 12B, 12C, 12D and 12E together illustrate with an example the manner in which block 1200 provides the ability to either connect or disconnect nodes 645 and 655 using any of the masks up to 4 times. Block 1200 is shown containing two cells 1210 and 1220, with three fingers (1230-1 through 1230-3 and 1240-1 through 1240-3) respectively. As described below, the two cells together support four changes to a bit of the version number, e.g., from 0 to 1 to 0 to 1 to 0.

Though the sequence of changes are described as starting from 0, it should be understood that first change can be implemented from 1 to 0, and four changes would be supported even in that scenario. Such alternative embodiments are contemplated to within the scope and spirit of various aspects of the present invention.

The first two changes (from 0 to 1 to 0) can be implemented with single cell 1210 as described above (FIGS. 11A-11C) without changing the structure of cell 1220 of FIG. 12A. That is, the structure of cell 1220 remains the same in FIGS. 12A through 12C, while the structure of cell 1210 changes similar to cell 1100 in FIGS. 11A through 11C respectively.

Thus, it may be appreciated that the first two changes can be implemented using any layer in a single cell as in FIGS. 11A-11C (or FIGS. 12A through 12C). If a third change (from 0 to 1) needs to be implemented using layer M1, then the structure of cell 1220 needs to be changed. The changed structure is depicted in FIG. 12D.

FIG. 12D represents a structure in which block 1200 is in a connect mode. The connection is achieved by laying metal M1 in finger 1240-3 of cell 1220. The connection between nodes 645 and 655 causes a value 1′ to be provided on path 635. It is now assumed as fourth change (from 1 to 0) needs to be implemented with M3 release only.

FIG. 12E represents a structure in which block 1200 is in disconnect mode. The disconnection is achieved by removing metal M3 from finger 1240-3 of cell 1220 (which was causing a connect status), which causes a value ‘0’ to be provided on path 635. Thus, all possible changes of bit 2 with any layer can be achieved by providing two cells (1210 and 1220) in block 1200.

Now hypothetically assuming that the value is to be changed to 1 using metal M1 mask, block 1200 of FIG. 12E cannot be changed any further to achieve the desired value using only M1 mask. In particular, connection with M1 mask is not possible in block 1200 as all fingers are already filled with M1 mask (in FIG. 12E). Thus, extra cells are required to provide more than four changes with two cells.

Accordingly, bits 0 (LSB) and 1 of a 4 bit version identifier can be implemented with 8 and 4 cells respectively in a block. All possible changes of bits 0 and 1 can be achieved by laying/removing any of the metal layers in a corresponding cell in a block in a similar manner as described above with reference to bits 3 (MSB) and 2.

In general, total number of cells required with approach three for an N-bit register used to store a version identifier is (2^{N}−1). For a 4-bit register with three layers, approach two needs 12 cells and approach three needs 15 cells whereas with five layers, approach two needs 20 cells and approach three needs only 15 cells. In general, as the number of layers increases, approach three may provide a more area efficient implementation since the number of cells required is less compared to approach two.

### 6. Conclusion

While various embodiments of the present invention have been described above, it should be understood that they have been presented by way of example only, and not limitation. Thus, the breadth and scope of the present invention should not be limited by any of the above described exemplary embodiments, but should be defined only in accordance with the following claims and their equivalents.

What is claimed is:

1. A method of changing a value of a bit when the design used to fabricate integrated circuits changes, said method comprising:
implementing an approach which enables said value to be changed a plurality of times by redesigning a single mask alone a corresponding number of times, wherein said single mask is contained in a plurality of masks used to fabricate integrated circuits according to a first design of said integrated circuit;
fabricating a first integrated circuit according to said plurality of masks, wherein said plurality of masks cause said first integrated circuit to store a first value for said bit;
changing said single mask to correspond to a second design;
further changing said single mask according to said approach to cause a second value to be stored for said bit; and
fabricating a second integrated circuit according to said single mask such that said second integrated circuit is generated to store said second value.

2. The method of claim 1, wherein said bit comprises a bit of a version identifier of said first integrated circuit and said second integrated circuit.

3. The method of claim 1, wherein said approach enables said bit value to be changed any number of times by changing only said single mask.

4. The method of claim 3, wherein said approach comprises:
providing in said first mask an option to connect a first input and a second input to a first output and a second output in a straight configuration or a cross configuration, wherein said first input is coupled to said first output and said second input is coupled to said second output in said straight configuration, said first input being coupled to said second output and said second input being coupled to said first output in a cross configuration,
wherein one of two logical values is provided on one of said first input and said second input, and another one of the two logical values is provided on the another one of said first input and said second input,
wherein said first value is changed to said second value by changing configuration from cross to straight or straight to cross.

5. The method of claim 4, wherein said approach further comprises placing said first input diagonally opposite to said second input, and said second output diagonally opposite to said first output, wherein first input, said second input, said second output and said first output are placed on a layout portion.

6. The method of claim 5, wherein said first mask corresponds to a layer which can be laid as a long strip, wherein said approach comprises:
laying said layer to achieve a desired connection from said first input to one of said first output or said second output, and not providing a connection from said first input to the another one of said first output and said second output.

7. The method of claim 6, wherein said layer comprises a metal.

8. The method of claim 5, wherein said first mask corresponds to a via layer, wherein said approach comprises:
laying a connecting layer and a disconnecting layer between said first input and said first output; and
designing said first mask to lay vias on said connecting layer to cause said first input to be connected to said first output, and on said disconnecting layer to cause said first input to be disconnected from said first output.

9. The method of claim 8, wherein each of said connecting layer and said disconnecting layer comprises a metal.

10. The method of claim 3, wherein said approach comprises:
providing a register bit cell containing two inputs, wherein said register bit cell generates one logical value when said two inputs are in a connected status and another logical value when said two inputs are in a disconnected status; and
providing a cell associated with said first mask, wherein said cell enables said first mask to achieve one of said connected status and said disconnected status, and any of said plurality of masks to achieve the remaining one of said connected status and said disconnected status.

11. The method of claim 10, further comprising providing a plurality of cells, with each of said plurality of cells providing a corresponding one of said plurality of masks the ability to achieve one of said connected status and said disconnected status and any of said plurality of masks to achieve the remaining one of said connected status and said disconnected status.

12. The method of claim 11, wherein said one of said connected status and disconnected status comprises connected status.

13. The method of claim 11, wherein said connected status is achieved by laying all layers in a finger contained in said cell.

14. The method of claim 1, wherein said approach comprises:
providing a register bit cell containing two inputs, wherein said register bit cell generates one logical value when said two inputs are in a connected status and another logical value when said two inputs are in a disconnected status; and
providing a cell containing a plurality of fingers, wherein each of said plurality of fingers contains space for a plurality of layers to be laid by corresponding ones of said plurality of masks, wherein said disconnected status is achieved when at least one of said plurality of layers is missing in each of said plurality of fingers, and wherein said connected status is achieved when all of said plurality of layers are present in at least one of said plurality of fingers.

15. The method of claim 14, wherein said approach further comprises providing a number of cells proportionate to a number of times said bit can change.

16. A method of allowing the value of a bit stored in integrated circuits to be changed when the design of integrated circuits changes, said method comprising:
providing in a first mask an option to connect a first input and a second input to a first output and a second output in a straight configuration or a cross configuration, wherein said first input is coupled to said first output and said second input is coupled to said second output in said straight configuration, said first input being coupled to said second output and said second input being coupled to said first output in a cross configuration,
wherein one of two logical values is provided on one of said first input and said second input, and another one of the two logical values is provided on the another one of said first input and said second input,
wherein said first value is changed to said second value by changing configuration from cross to straight or straight to cross.

17. The method of claim 16, wherein said method further comprises placing said first input diagonally opposite to said second input, and said second output diagonally opposite to said first output, wherein first input, said second input, said second output and said first output are placed on a layout portion.

18. The method of claim 17, wherein said first mask corresponds to a layer which can be laid as a long strip, wherein said method comprises:
laying said layer to achieve a desired connection from said first input to one of said first output or said second output, and not providing a connection from said first input to the another one of said first output and said second output.

19. The method of claim 18, wherein said layer comprises a metal.

20. The method of claim 17, wherein said first mask corresponds to a via layer, wherein said method comprises:
implementing a connecting layer and a disconnecting layer between said first input and said first output; and
designing said first mask to lay vias on said connecting layer to cause said first input to be connected to said first output, and on said disconnecting layer to cause said first input to be disconnected from said first output.

21. The method of claim 20, wherein each of said connecting layer and said disconnecting layer comprises a metal.

22. The method of claim 21, wherein some of said plurality of masks are implemented similar to said first mask, wherein said some of said plurality of masks are likely to be changed when said design changes.

23. The method of claim 13, wherein said bit comprises a bit in a version identifier of integrated circuits.

24. A method of allowing the value of a bit stored in integrated circuits to be changed when the design of integrated circuits changes, said method comprising:
providing a register bit cell containing two inputs, wherein said register bit cell generates one logical value when said two inputs are in a connected status and another logical value when said two inputs are in a disconnected status; and
providing a cell containing a plurality of fingers, each of said plurality of fingers containing space for a plurality of layers, wherein each of said plurality of layers is to be laid by a corresponding one of a plurality of masks using which said value of said bit is sought to be controlled, wherein whether said plurality of layers are laid or not determines whether said two inputs are in said connected status or said disconnected status.

25. The method of claim 24, further comprising providing a plurality of cells, with each of said plurality of cells providing a corresponding one of said plurality of masks the ability to achieve one of said connected status and said disconnected status, and any of said plurality of masks to achieve the remaining one of said connected status and said disconnected status, wherein said plurality of cells comprise said cell.

26. The method of claim 25, wherein said one of said connected status and disconnected status comprises connected status.

27. The method of claim 26, wherein said connected status is achieved by laying all layers of one of said plurality of fingers contained in said cell.

28. The method of claim 27, wherein said plurality of cells comprises a block, and wherein a plurality of blocks are provided associated with a corresponding plurality of bits, said method further comprises providing said block and said register bit cell associated with each of said plurality of bits.

29. The method of claim 24, wherein said method further comprises providing a number of cells proportionate to a number of times said bit can change, wherein said number of cells comprises said cell.

30. The method of claim 29, wherein 2^{N-1} cells are provided associated with each of a plurality of bits, wherein N represents a position number of a bit counted from one starting with a most significant bit, said plurality of bits forming a digital value stored in an integrated circuit.

31. An integrated circuit generating a desired bit value, said integrated circuit comprising:
a plurality of logical portions, wherein each of said logical portions is laid by using a corresponding one of a plurality of masks used to fabricate said integrated circuit, wherein each of said logical portions receives a first input and a second input, and generates a first output,
wherein each of said logical portions generates a first logical value or a second logical value on said first output depending on a configuration, said first input and said second input,
wherein the logical value generated by each logical portion is provided as an input to a next one of said plurality of logical portions,
wherein said desired bit value can be caused to be changed by redesigning any of said plurality of masks to change the configuration of a corresponding logical portion.

32. The integrated circuit of claim 31, wherein one of said first logical value and said second logical value is provided on said first input, and another one of said first logical value and said second logical value is provided on the another one of said first input and said second input of a logical portion of said first one of said plurality of masks, and
wherein a first output and a second output of each logical portion are respectively coupled to a first input and a second input of a logical portion of a next one of said plurality of masks, and
wherein said configuration comprises a straight configuration or a cross configuration, wherein said first input is coupled to said first output and said second input is coupled to said second output in said straight configuration, said first input being coupled to said second output and said second input being coupled to said first output in a cross configuration

33. The integrated circuit of claim 32, wherein said first input is placed diagonally opposite to said second input, and said second output is placed diagonally opposite to said first output.

34. The integrated circuit of claim 33, wherein one of said plurality of logical portions comprises:
a first metal connecting said first input to said first output; and
a second metal without connecting said first input to said first output.

35. The integrated circuit of claim 34, further comprising a via laid on said first metal to achieve a connection between said first input and said first output.

36. The integrated circuit of claim 34, further comprising a via laid on said second metal to leave said first input and said first output unconnected.

37. The integrated circuit of claim 36, wherein said bit value comprises a bit of a version identifier of said integrated circuit.

38. An integrated circuit generating a desired bit value, said integrated circuit comprising:
a register bit cell containing two inputs, wherein said register bit cell generates one logical value when said two inputs are in a connected status and another logical value when said two inputs are in a disconnected status; and
a cell containing a plurality of fingers, each of said plurality of fingers containing space for a plurality of layers, wherein each of said plurality of layers is laid by a corresponding one of a plurality of masks using which said value of said bit is sought to be controlled, wherein whether said plurality of layers are laid or not determines whether said two inputs are in said connected status or said disconnected status.

39. The integrated circuit of claim 38, further comprising a plurality of cells, with each of said plurality of cells providing a corresponding one of said plurality of masks the ability to achieve one of said connected status and said disconnected status, and any of said plurality of masks to achieve the remaining one of said connected status and said disconnected status such that any of said plurality of masks alone can be redesigned to generate said desired bit value, wherein said plurality of cells comprises said cell.

40. The integrated circuit of claim 39, wherein said one of said connected status and disconnected status comprises connected status.

41. The integrated circuit of claim 40, wherein said plurality of cells comprises a block, and wherein a plurality of blocks are provided associated with a corresponding plurality of bits.

42. The integrated circuit of claim 41, further comprising a plurality of blocks and a plurality of register bit cells, wherein each of said plurality of blocks and a corresponding one of said plurality of register bit cells is associated with one of a plurality of bits.

43. The integrated circuit of claim 38, further comprises providing a number of cells proportionate to a number of times said bit can change.

44. The integrated circuit of claim 43, wherein 2^{N-1} cells are provided associated with each of a plurality of bits, wherein N represents a position number of a bit counted from one starting with a most significant bit.

45. The integrated circuit of claim 43, wherein said desired bit value comprises a bit of a version identifier.
